(19) United States
(12) Patent Application Publication
(10) Pub. No.: US 2006/0034538 A1
(43) Pub. Date: Feb. 16, 2006

(54) Method and system of automating echocardiogram measurements and reporting

(75) Inventors: Glenn Potter, Milwaukee, WI (US); W. Chad Neller, Wauwatosa, WI (US); Robert Katka, Pewaukee, WI (US); Bob Baumgartner, Hartland, WI (US)

Correspondence Address: MICHAEL BEST & FRIEDRICH, LLP, 100 E WISCONSIN AVENUE, MILWAUKEE, WI, 53202, US

(73) Assignee: Agfa Corporation, Ridgefield Park, NJ (US)

(21) Appl. No.: 10/955,986

(22) Filed: Sep. 30, 2004

Related U.S. Application Data
(60) Provisional application No. 60/590,655, filed on Jul. 23, 2004.

(51) Int. Cl. G06K 9/42

(52) U.S. Cl. 382/256

(57) ABSTRACT

A system for generating measurements and calculations on an image previously generated during a procedure. In one embodiment, the system includes an image display application configured to display the image previously generated during the procedure and a supplemental measurement tool configured to display one or more measurement types to a user, allow the user to select a measurement type, record a measurement made by the user of the selected measurement type on the displayed image, and automatically generate one or more calculations based on the recorded measurements.

### RELATED APPLICATIONS

The present application claims priority to U.S. provisional patent application Ser. No. 60/590,655 titled “METHOD AND SYSTEM OF AUTOMATING ECHOCARDIOGRAM MEASUREMENTS AND REPORTING,” filed on Jul. 23, 2004.

### FIELD OF INTEREST

Embodiments of the invention generally relate to automating echocardiography procedures, echocardiograms, or more broadly ultrasonography procedures. More specifically, embodiments of the invention provide a system and method for generating accurate measurements and resulting calculations during and after an ultrasonography procedure and incorporating the measurements and corresponding calculations into a procedure report.

### BACKGROUND OF THE INVENTION

A variety of imaging technologies are used in medicine. For example, an echocardiogram is an image of the heart generated using ultrasonic waves. Generally, a technician generates measurements of an image during its acquisition. Continuing the echocardiogram example, a technician (or physician) might measure the length, width, or other dimensions of the heart or its parts. The image may be displayed on an ultrasound system (sometimes referred to as an “echo cart”), and various measurements and calculations recorded. These measurements and calculations are then forwarded to a physician or specialist (e.g., cardiologist, obstetrician, etc.) who uses the measurements and calculations to diagnose the patient. The physician or specialist also receives the image produced by the echo cart, but generally does not have tools to generate measurements and calculations. The physician or specialist must rely on the measurements and calculations made by the technician at the time of the procedure. If any measurements or calculations are missing or erroneous, the physician or specialist must rely on the remaining measurements to make a diagnosis or request the procedure be performed again. If the technician provides the physician with inaccurate data, the cardiologist may misdiagnose the patient.

After the physician or specialist generates a diagnosis, they often dictate or hand-write the diagnosis into a report. Since the data is manually entered in the report, data may be reported incorrectly. Since the diagnosis includes numerous measurements, calculations, and other numerical data, errors are likely.

### SUMMARY OF THE INVENTION

Embodiments of the invention are designed to supplement or replace the current method of performing and reporting measurements and calculations generated during an ultrasonography procedure or other imaging procedure. Embodiments of the invention allow a physician or specialist to generate measurements and derived calculations on a workstation and not be totally reliant on measurements performed at the time of the procedure. The method allows for a more critical review of the images and subsequently may improve the interpretative value of the study.

Embodiments of the invention also provide storage of the measurements and calculated values as discrete data, and possibly images, in an ultrasound procedure report. The ultrasound procedure report may be considered an ancillary report that contains the discrete data generated from an analysis of the echo images. The data contained in this ancillary report may be imported into a full procedural report that may include additional data including physician comments, findings, conclusions, recommendations, and diagnosis. By automating the transfer of data, including the measurements and calculations taken during and after the procedure, and the diagnosis based on the measurements and calculations, possible human error is reduced.

In some embodiments, the invention provides a system for generating measurements and calculations on an image previously generated during a procedure. The system includes an image display application configured to display the image previously generated during the procedure; and a supplemental measurement tool configured to display one or more measurement types to a user, allow the user to select a measurement type, record a measurement made by the user of the selected measurement type on the displayed image, and automatically generate one or more calculations based on the recorded measurements.

In some embodiments, the invention provides a method of generating measurements on an echo image previously generated during a procedure. The method includes the steps of displaying the echo image previously generated during the procedure, displaying measurement types to a user, allowing the user to select a first measurement type, determining the first measurement type selected by the user, recording a first measurement of the first selected measurement type made by the user, and displaying the first measurement of the first selected measurement type made by the user.

In some embodiments, the invention provides a computer-readable medium. The computer-readable medium containing instructions for obtaining procedure data from a displayed image, displaying one or more measurement types, selecting one of the one or more measurement types, determining a measurement type selected, recording a measurement of the selected measurement type made by the user, displaying the measurement of the selected measurement type made by the user, and generating one or more calculations based on the recorded measurement.

Other features and advantages of embodiments the invention will become apparent to those skilled in the art upon review of the following detailed description, claims, and drawings.

### BRIEF DESCRIPTION OF THE DRAWINGS

In the drawings:

FIG. 1 is a schematic illustration of a system for conducting an imaging procedure and generating a procedure report.

FIG. 2 is a flow chart illustrating the process of conducting an imaging procedure and generating a procedure report.

FIG. 3 is a schematic illustration of the components of an echo image display application.

FIG. 4 illustrates an exemplary screen shot of an echo image display application with a supplemental measurement tool dialog box.

FIG. 5 illustrates the supplemental measurement tool dialog box of FIG. 4.

FIG. 6 is an exemplary work area selection tool of the supplemental measurement tool of FIG. 5.

FIG. 7 is an exemplary measurement menu of the supplemental measurement tool of FIG. 5.

FIG. 8 is an exemplary calculation menu of the supplemental measurement tool of FIG. 5.

FIG. 9 is an exemplary class diagram used to implement one embodiment of the supplemental measurement tool.

FIG. 10 is a diagram illustrating interactions between exemplary classes of a supplemental measurement tool that takes place during measurement recordation.

FIG. 11 is a diagram illustrating interactions between exemplary classes of a supplemental measurement tool that take place to complete a report of an echo study.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

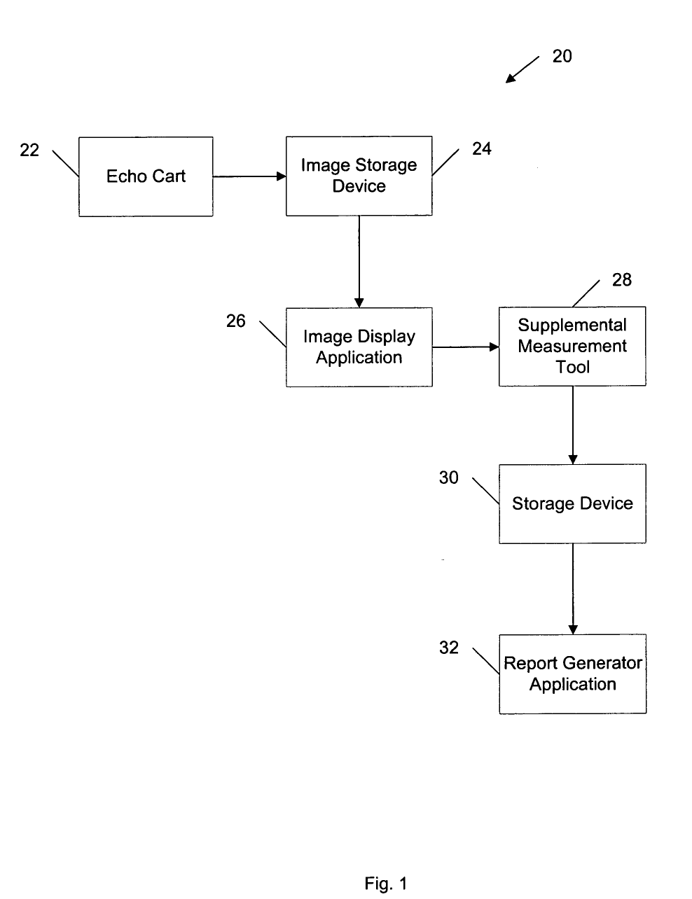

FIG. 1 illustrates an exemplary system 20 configured to create an echo image and a final report based on the image. Before explaining the system 20 further, a brief description of studies and reports, as often used by those of ordinary skill in the art, is provided. Generally, a study is the result of a patient's single visit to a cardiology, radiology, or similar department. A study typically consists of the data (images, waveforms, other physiological measurements (such as hemodynamics)) acquired during the visit. In general, a study progresses through the following states:
Scheduled (not yet begun)
In progress (images, waveforms, other physiological measurements are being acquired by a medical device, such as an echo cart)
Complete (all medical devices have finished acquiring data)

After the study is complete further analysis may be performed on the acquired data.

In addition, a report may be generated. A study report generally progresses through the following states:
Preliminary
Completed
(optional)Amended-Completed

If a department has a procedural reporting application, an ancillary report may be generated. The ancillary report may be imported into a full procedure report where additional analysis and data may be recorded. The full procedure report is a new, separate report that goes through its own Preliminary-Completed-(optional)Amended-Completed states.

The system 20 includes an ultrasound or echocardiogram device 22, which may be placed on a cart or similar device to enhance portability. In some instances such a device is called an “echo cart.” The echo cart 22 is used by a technician to capture an echo image during a procedure on a patient. The procedure may include a fetal ultrasound, echocardiogram, or other procedure where high frequency sound waves (“ultrasound waves”) and their echoes are used to generate an echo image of an object that cannot otherwise be easily seen and observed, such as a human heart or fetus. The echo cart 22 transmits a large number of ultrasound waves and records the time, intensity, or other characteristic of reflected echoes of the transmitted ultrasound waves and uses that information to render an echo image. The echo cart 22 includes hardware and software necessary to generate, transmit, record, and process ultrasound waves and their echoes during a procedure to generate an echo image. For example, the echo cart 22 may include a transducer probe, a transducer pulse control, a processor, a display, a keyboard, and a printer. The echo cart 22 may include additional components to those listed above or any subset thereof. Ultrasound hardware and software used during echocardiogram procedures are well known in the art and therefore not described in detail.

The echo cart 22 (or processor of the echo cart 22) may also be configured to calibrate the echo image captured during the procedure or may include a process for allowing the technician using the echo cart 22 to manually enter calibration data to the echo cart 22. The calibration data may include a scale for the image (e.g., a distance scale or time scale), the type or mode of the captured image (e.g., two-dimensional, M-Mode, or Doppler), and/or additional data that may be used to set the environment parameters of the image. The echo cart 22 may also be configured to automatically, or through interactions with the technician, make and record measurements, and any corresponding calculations, from the captured image. The echo cart 22 may also be further configured to obtain additional data regarding the patient, the type of procedure being performed, the technician, the date and time of the procedure, or the like. This additional data and any previously obtained data such as the calibration data, the measurements and calculations, or any combination thereof may be saved with the echo image by the echo cart 22 as procedure data. The procedure data may be recorded directly into the image or may be placed in a header included with the image.

The system 20 also includes an image storage device 24 that stores the echo images and any procedure data captured by the echo cart 22. The image storage device 24 may obtain the echo images and procedure data from the echo cart 22 over a wired or wireless connection that may be a direct connection or an indirect connection through a network containing both the echo cart 22 and the image storage device 24. The echo images and procedure data may also be transferred by storing the echo images and procedure data on a portable memory device such as a magnetic disk and physically taking the disk to the image storage device 24 and loading the images from the disk to the image storage device 24. The image storage device 24 may represent a database, a hard-disk drive, a collection of magnetic disks or tape, or other storage mechanism. The image storage device 24 may save each echo image captured by the echo cart 22 for a particular patient separately or, if multiple echo images are created for a particular patient during a single procedure, save the set of images as a single unit.

The system 20 further includes an image display application 26 configured to access echo images and procedure data stored in the image storage device 24 and display them to a user. The image display application 26 displays the echo images and procedure data in order to allow a physician, technician, nurse, physician assistant, medical student, specialist, or the like to view the echo images and procedure data captured during a procedure and make a diagnosis. The image display application 26 may access the stored echo image and procedure data through a number of possible connections including but not limited to a direct connection, an indirect connection, a wired connection, a wireless connection, or any combination thereof. The image display application 26 may also access the images in the image storage device 24 by requiring the physician to transport the images by using a portable memory device to physically transfer the images from the image storage device 24 to the image display application 26. The images may also be automatically transferred and loaded by the image display application 26. The image display application 26 may provide the physician with a list of stored images and allow the physician to select which image, or set of images, he or she wishes to display.

The image display application 26 may also provide a calibration tool that the physician may use to calibrate, or recalibrate, the displayed image. The image display application 26 may also include other tools that can be used to adjust the size or orientation of the displayed image, print the echo image and/or procedure data, play a series of images in real-time, and/or record an audio diagnosis regarding the displayed echo image.

The system 20 also includes a supplemental measurement tool 28. In some embodiments, the supplemental measurement tool 28 is used within the image display application 26 to record additional measurements and determine additional calculations after the ultrasonography procedure. The supplemental measurement tool 28 is configured to interact with the image display application 26 and record measurements on the echo image(s) displayed by the image display application 26 and compute calculations based on the recorded measurements. The supplemental measurement tool 28 may also be configured to use the tools provided by the image display application 26. The supplemental measurement tool 28 may be further configured to obtain the procedure data and use the data when generating additional measurements and calculations. When recording additional measurements the supplemental measurement tool 28 may be configured to graphically display the additional recorded measurements on the echo image(s). The supplemental measurement tool 28 may be used to make additional measurements and corresponding calculations on the echo image(s) in addition, or in place of, the measurements and calculations made by the technician on the echo cart 22, and automatically save the measurements and/or calculations. The technician, who initially created the images and any corresponding data, may also use the supplemental measurement tool 28 to check their measurements and calculations and correct any mistakes or inconsistencies.

The system 20 may also include a storage device 30 where the images and/or the corresponding measurements and calculations recorded by the supplemental measurement tool 28 are stored. The storage device 30 may obtain the echo images and data from the supplemental measurement tool 28. The obtained images and corresponding measurements and calculations may be previously processed and formatted by the supplemental measurement tool 28 or may be additionally formatted by the storage device 30 so that the images and data can be accessed later for intended uses, such as automatically generating procedure reports. As described for the image storage device 24, the storage device 30 may represent a database, hard-disk drive, collection of magnetic disks, etc.

The system 20 may also further include a report generator 32 that is configured to generate a procedure report from the data stored in the storage device 30. The report generator 32 may access the storage device 30 through a direct or indirect network, wired or wireless connection or may use portable memory devices and human interaction to physically obtain objects from the object repository 30. The report generator application 32 may be further configured to associate a measurement or calculation stored in the storage device with a generated report.

The system 20 may include additional components. For example, a template generator (not shown) may be used create templates and/or forms used by the supplemental measurement tool 28, storage device 30, and/or the report generator application 32 to aid in the processing of data. Other intermediary formatting components such as a business logic server or dictionary database may be used to apply rules and formatting to the data obtained for the procedure report.

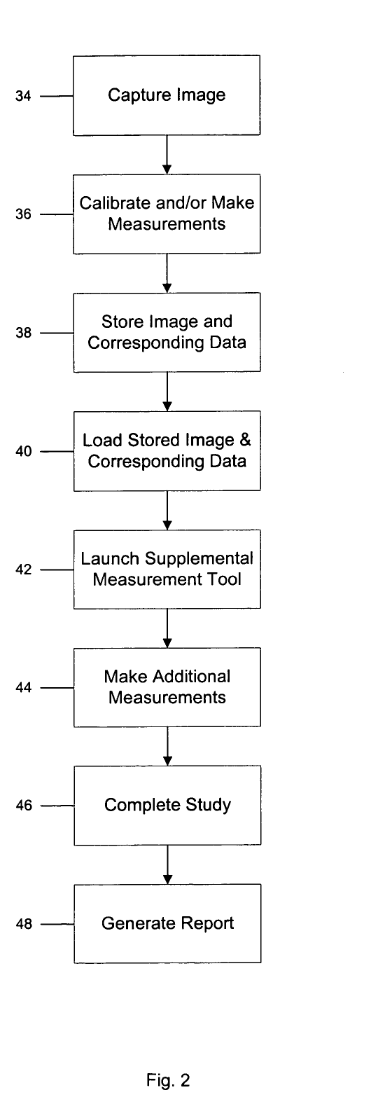

FIG. 2 is a flow chart illustrating an exemplary process of generating a procedure report using the system 20. Starting at block 34, a technician performs a procedure ad captures one or more echo images using the echo cart 22. Capturing the echo images may also include obtaining or entering additional data regarding the procedure, including, but not limited to, data regarding the type of procedure to perform, the date and time the procedure is being performed, the patient's name and/or identifier, and the technician's name and/or identifier. Next, at block 36, the technician, or the echo cart 22, calibrates the echo image (if applicable) and makes whatever measurements the procedure entails. Different patients may require different measurements to be made to generate needed calculations. For example, an adult patient suffering from a heart murmur or high blood pressure may require a different procedure requiring different measurements than an unborn baby with an underdeveloped heart. The physician of the patient may specify the procedure and/or measurements that the technician should make. The technician may be further trained and/or instructed to compute certain calculations based on the measurements acquired. The echo cart 22 may also be configured to automatically, without the aid of the technician, calibrate the image, take measurements, and/or compute calculations from the measurements.

After the technician has calibrated the echo image(s) and made any measurements and/or calculations required, the technician stores the echo image(s) and corresponding procedure data (block 38). The technician may store the echo image(s) and procedure data by clicking on a save icon or choosing a save option from a menu displayed on the echo cart 22 or may save the echo image(s) and procedure data to a disk and transport the disk to the physician requesting the procedure or a central location or data terminal where the echo image(s) and procedure data are taken from the disk and stored to the image storage device 24. Along with storing the echo image(s) and procedure data to disk and/or the image storage device 24, a copy of the echo image(s) and procedure data may be sent to the physician. The physician may receive the echo image(s) and procedure data in an email message, in a paper document, or the like. The sent echo image(s) and procedure data may be used as an indication to the physician that the procedure is complete and ready for diagnosis. The paper document may also serve as a permanent record to be placed in the patient's medical record.

At block 40, the physician uses the image display application 26 to view the echo image(s) and corresponding procedure data generated during a procedure. To generate a study of the procedure and make a diagnosis, the physician launches the supplemental measurement tool 28 (block 42). Once the supplemental measurement tool 28 has been started, the physician may use the tool 28 to make additional measurements and calculations on the currently displayed image (block 44). At block 46, the physician has made all the measurements and calculations that he or she needs to make a diagnosis and completes the study of the procedure. Completing the study of the procedure may cause all of the measurements and calculations generated by the physician using the supplemental measurement tool 28 to be processed and saved (block 46). Any measurements and calculations generated by the technician using the echo cart may also be saved with the measurements and calculations generated by the supplemental measurement tool 28.

After the study of the procedure has been completed and the measurements and calculations generated by the supplemental measurement tool 28 has been saved, a procedure report may be generated from the saved data (block 48). Generating the procedure report may occur automatically after the physician completes the study or may require the physician or other user to initiate the process by clicking on an icon, selecting a menu selection, pressing a combination of keys, or the like. The report may include the echo images, the procedure data, the measurements and calculations recorded using the echo cart 22 and/or the supplemental measurement tool 28, or any combination thereof. The report may also include additional data such as comments from the physician and past procedure results.

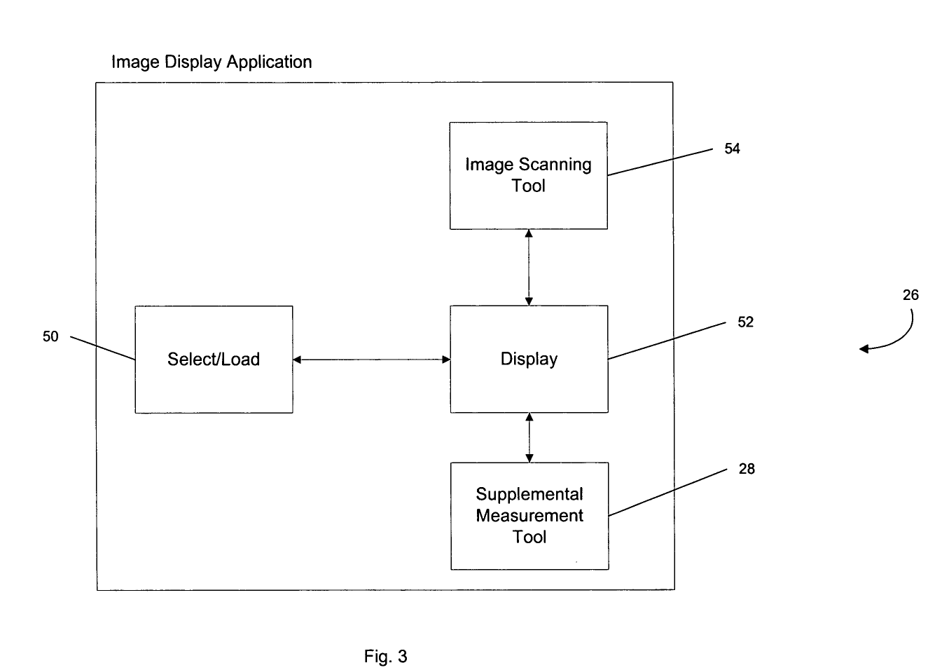

FIG. 3 is a schematic illustration of exemplary components of the image display application 26. In some embodiments, the image display application 26 includes a select/load module 50, a display module 54, an image scanning tool 54, and the supplemental measurement tool 28. The select/load module 50 may be configured to present a listing of possible images to display. A physician may be able to choose an image to display by selecting a name assigned to an image from a graphical user interface (“GUI”). Upon selecting an image to display, the select/load module 50 may instruct the display module 52 to display the selected echo image on the screen. The display module 52 may be configured to open the saved echo image, obtain the data and render the echo image on a display of a workstation or other viewing apparatus. The display module may also interact with the image scanning tool 54. The image scanning tool 54 may be configured to scan an image captured by the echo cart 22 and provide data to the display module 52 so that the image and any measurements and/or calculations captured by the echo cart 22 are displayed. The image scanning tool 54 may be a tool such as the Freeland screen reader available from Freeland Systems (www.freelandsystems.com) configured to gather data regarding an image. The scanning tool 54 may be configured to scan the ultrasound image to obtain the data or may be configured to scan a report page also generated by the echo cart 22 that provides the numerical data such as measurements and calculations captured by the echo cart 22.

After data is obtained by the scanning tool 54 and provided to the display module 52, the display module renders the image and any corresponding measurements and calculations on a display of a workstation or similar viewing device. The physician may then launch the supplemental measurement tool 28 and generate additional measurements and calculations. In some embodiments, measurements and calculations obtained by the scanning tool 54 are provided to the supplemental measurement tool 28 and are listed and treated as measurements and calculations generated by the supplemental measurement tool 28.

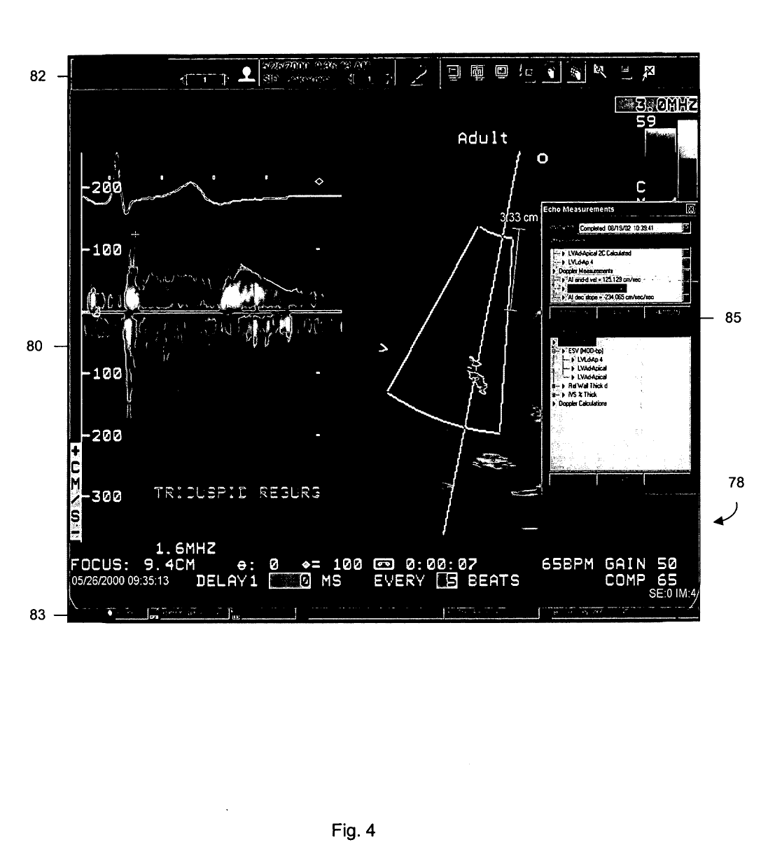

FIG. 4 is an exemplary screen shot 78 of output generated by the image display application 26. The output shown in the screen shot may be displayed on a display of a workstation executing the image display application 26 or the like. An echo image 80, captured by the echo cart 22 is displayed on the screen 78. The echo image 80 includes both the echo image captured during the procedure and any additional procedure data captured and/or determined by the echo cart 22 and/or physician performing the procedure. For example, the image may include the data and time of the procedure, the name of the echo cart used to capture the image, characteristics of the patient, operating parameters of the echo cart, etc.

The screen shot 78 also includes a tool bar 82 and a status bar 83. The tool bar 82 may include icons that a physician can click on to select or drag and drop onto the image, drop-down menu selections, a command prompt, or any combination thereof. Using a cursor control device (not shown), a physician may use the toolbar 82 to open and close an echo image 80, start and stop a recording tool used to record diagnostic information, change the direction, size, orientation, of the image, play a series of images in real time, or the like. The status bar 83 may include current operating parameters of the echocardiogram image display application 26 such as current date and time.

The image display application 26, or workstation executing the application, may require that a physician be identified and authenticated before using the image display application 26 in order to ensure that only authorized personnel are using the image display application 26 or other applications related to the image display application being executed by the workstation executing the image display application 26. The physician may have to provide a username and may also be prompted for a password for authentication purposes. The entered username or other form of physician identification may also appear in the status bar 83.

The tool bar 82 may also include an icon, menu selection, command, etc. to launch the supplemental measurement tool 28. The supplemental measurement tool 28 provides a number of functions to the physician that may be used with and applied to the echo image 80 currently displayed by the image display application 26. The supplemental measurement tool 28 may be configured to use tools and data provided by the image display application 26, such as audio record tools, image orientation tools, image navigation tools, or the like.

To start using the tool 28, the physician may select a supplemental measurement tool button in the tool bar 82 of the echocardiogram image display application. Other mechanisms for launching the supplemental measurement tool are possible, including choosing the application from a menu, clicking on an icon, or pressing one or a combination of keys on a keyboard. The supplemental measurement tool 28 may be configured to require authorization upon launching the tool. Authorization may be gained through the image display application 26 if the physician was prompted for username and password when executing the image display application 26. In order to associate individual measurements and calculations generated by the supplemental measurement tool 28, the tool 28 requires the physician to enter identifying information. The identifying information may include the physician's name, username, identification number, or other unique identifier. The physician may also be required to provide authentication data such as a password or access code to the supplemental measurement tool 28. The supplemental measurement tool 28 may prompt the physician for this information or may gain the information from a card reader or biometric authorization device.

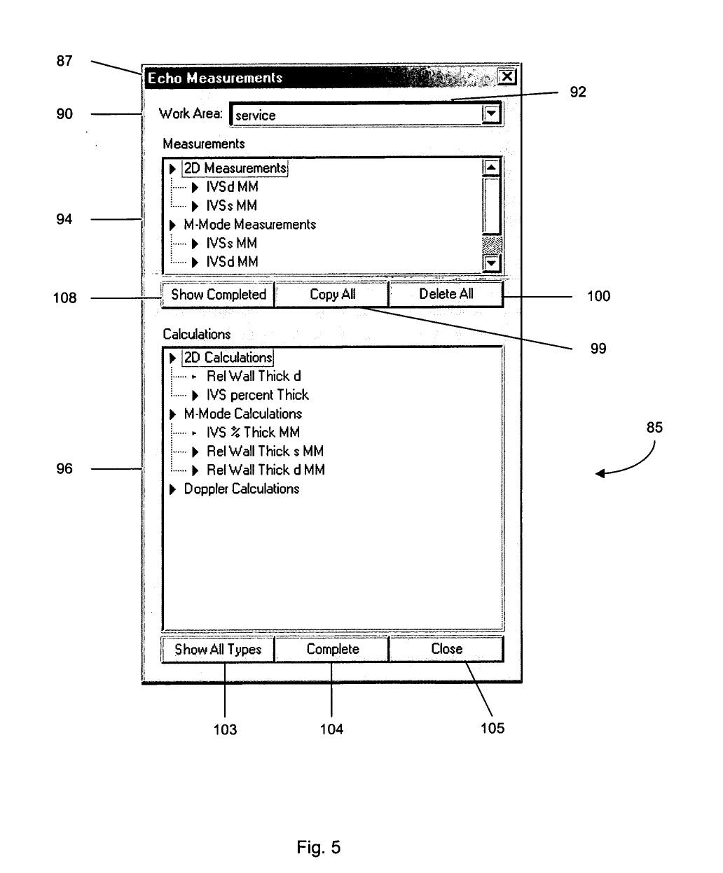

Once the physician launching the supplemental measurement tool 28 has been identified and authorized, the supplemental measurement tool 28 displays a tool dialog 85 (FIG. 5) as a dialog window or box on top of the echo image 80 so that both the echo image 80 and the tool dialog 85 can be seen. Other arrangements and placements, however, for the tool dialog 85 are possible that allow the physician to view the full echo image 80 while using the supplemental measurement tool.

The tool dialog 85 may include a title section 87 that includes a specific name of the supplemental measurement tool 28 or a company name, an exit icon for closing the tool dialog 85, a resizing button that can increase or decrease the size of the tool dialog 85, a minimizing button, or a button used to increase or change the font of the tool dialog. It should be apparent that other buttons and selections as also possible. The tool dialog 85 may also include a work area section 90. Each physician may be given a separate work area for his or her measurements and calculations recorded for each echo image. Each measurement and/or calculation is identified by or associated with a physician that recorded it. When the supplemental measurement tool 28 is launched it obtains procedure data regarding the echo image currently displayed by the image display application 26 and gathers together all of the measurements and/or calculations associated with the currently displayed image, or current procedure study. The supplemental measurement tool 28 then creates a separate work area for each physician that has created one or more measurements and/or calculations. If the current physician launching the supplemental measurement tool 28 doesn't already have existing measurements and/or calculations, the tool 28 creates an empty work area for the physician.

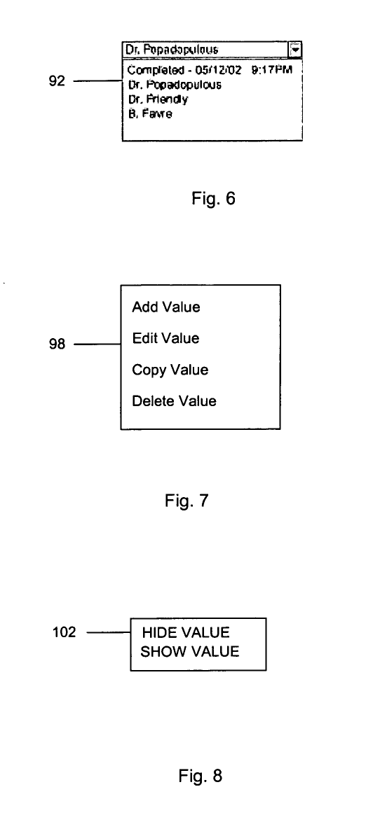

The work area section 90 may include a combo box 92, as seen in more detail in FIG. 6, which a physician may use to choose a work area to view. Only those measurements and calculations in the currently selected work area are displayed on the echo image 80. Each physician may be designated access rights when using the supplemental measurement tool 28, and a physician may be given the privilege to view other physicians' work areas. If a physician does select a work area other than their own, however, he or she may only be able to view the measurements and calculations of the work area. The physician may not be able to modify any measurements or calculations in another physician's work area.

After a physician has selected a work area, any measurements and calculations previously generated by the physician associated with the selected work area are displayed in a measurement tree 94 and a calculation tree 96 of the tool dialog 85. A corresponding graphical representation of each previously generated measurement also is displayed on the currently displayed echo image 80. If the physician has not previously generated measurements for the currently displayed image the work area may not contain any measurements or calculations and the echo image 80 may not contain any graphical measurement representations generated by the supplemental measurement tool 28.

To record measurements for the displayed echo image 80, a measurement type is selected from a measurement tree 94 displayed on the tool dialog 85. The measurement tree 94 contains a list of all the types of measurements that the physician may make on the displayed echo image 80. The list displayed in the measurement tree 94 may vary depending on the procedure data associated with the displayed echo image 80. For example, a measurement of lung dimensions would not be applicable for an echo image of a heart and, therefore, may not be listed in the measurement tree 94 for a procedure regarding a heart. Furthermore, the list displayed in the measurement tree 94 may vary depending on other characteristics of the displayed echo image 80 such as the spatial format of calibration regions on the image 80. For example, if the image contains only regions with Doppler spatially formatted regions, then only Doppler measurements and calculations may be listed. The physician may also be able to view all measurements regardless of the type of echo image displayed by the image display application 26 by selecting an option or button available on the tool dialog 85 such as a “Show All Types” button 103, which in some embodiments is a toggle switch that toggles from “Show All Types” to “Show This Type.”

Each measurement listed in the measurement tree 94 is associated with a measurement recording tool that is used to record that particular measurement on the image and generate a graphical representation of the measurement. For example, if a measurement requires two point selections to determine a measurement value, the measurement recording tool associated with the measurement may be configured to wait until the physician has selected two measurement points. The physician may select the measurement points by using a cursor control device and clicking or selecting locations on the displayed echo image 80. If more points are required, the measurement recording tool may be configured to record the measurement accordingly. The measurement recording tools used by the supplemental measurement tool 28 may be measurement recording tools provided by the image display application 26 or other similar applications. When using a cursor control device, such as a mouse, a physician may click on a measurement listed in the measurement tree 94.

If the physician single clicks on one of the measurements listed in the measurement tree 94 and if a measurement of that type has been previously generated, the previously generated measurement and corresponding graphical measurement representation may be highlighted on the displayed echo image 80. A double click on a measurement listed in the measurement tree 94 may work in the same manner as the single click except that, if a measurement has not been previously generated for the clicked measurement type the measurement recording tool associated with the selection measurement may be automatically activated so that a measurement of the selected type can be recorded. Recording a measurement on an echo image may include recording point selections made by a physician using a cursor control device and calculating the distance between selected points, the difference between sets of selected points, or other mathematical calculations regarding the selected points.

Once a measurement recording tool has been activated, the physician may select points on the displayed echo image 80 and the measurement recording tool uses the selected points to calculate a measurement value. After the measurement value has been calculated, the measurement recording tool may be deactivated, and a measurement value may be passed to the supplemental measurement tool 28 where it is displayed in the measurement tree 94. The supplement measurement tool 28 may also generate and display a graphical representation of the measurement, on the displayed echo image 80. FIG. 4 illustrates an example of this. In particular, an Aortic Value V₂ Velocity Time Interval (“Ao V₂ VTI”) measurement is shown. The measurement has a value of 3.33278 cm. The measurement value is displayed next to the measurement type in the measurement tree 94, and the corresponding graphical representation is shown on the echo image 80. The graphical representation may also display the calculated measurement value and/or the data the value was calculated from, for example the points selected by the physician. As described above, single clicking on a measurement type having a single measurement value highlights the single measurement value and/or corresponding graphical representation. Highlighting may include flashing the value and/or graphical representation, changing the font size or color of the value and/or graphical representation, etc.

The physician may record as many measurements as he or she wishes for each measurement type displayed in the measurement tree 94. If multiple measurements are made for a single measurement type, each measurement value may be displayed below the measurement type and a single parent value may be displayed next to the measurement type as the measurement value is displayed for a single measurement. The multiple measurement values may be hidden and may only be visible by expanding the view of the tree under the measurement type by selecting an expand icon or similar mechanism commonly used in tree diagrams such as the measurement tree 94. The single parent value may be the mean, average, maximum, minimum, etc. value of the multiple measurements. Each measurement type may have its own configuration specifying how the single parent value should be calculated. Single clicking on a measurement type with multiple measurement values may only cause the single parent value to be highlighted rather than an individual measurement value. Alternatively, single clicking on a measurement type with multiple measurement values may highlight all of the measurement values and/or corresponding graphical representations.

Besides double-clicking on a measurement type that has no measurement values, a new measurement may be recorded for measurement type, regardless of the number of measurement values the measurement type has, by right clicking on the measurement type. Right clicking on a measurement type launches a measurement pop-up menu 98, as shown in FIG. 7. As illustrated, the pop-up menu allows the physician to add or record a measurement value for the selected (right-clicked) measurement type. Selecting the “Add Value” option may launch the corresponding measurement recording tool for the selected measurement type as described above.

From the measurement pop-up menu 98, the physician may also choose to edit a measurement value previously recorded. If the physician selects this option the physician may be prompted to choose a specific measurement to edit from those listed below the selected measurement type. Editing a previously recorded measurement value may include physically moving the graphically displayed measurement and automatically updating the resulting measurement value, deleting the measurement value and corresponding measurement value and starting over, or the like.

The physician may also select the copy measurement value option to copy a previously recorded measurement from one work area to another. As with the edit option, the physician may be prompted to select an individual measurement to copy. This option may only be used if the physician has copy access rights to the work area where the measurement is being copied to and at least view access rights to the work area where the measurement is being copied from. A physician may utilize this feature to collaborate studies and converge a number of measurements generated in separate work areas into a single work area that may be used to generate a report. This feature may provide a beneficial tool to teaching hospitals where medical students may work together on a procedure analysis or be paired with a physician or specialist.

The physician may also delete a previously generated measurement by selecting the “Delete Value” option on the measurement pop-up menu 98. Again, the physician may be prompted to choose a specific measurement to delete.

The tool dialog 85 may also include a copy-all button 99 and a delete-all button 100 that may be used to copy all of the measurements recorded for one work area to another or delete all the measurements for one work area respectively. Although the buttons are shown as text-based buttons, graphical buttons may also be used.

In some embodiments, measurements created during the procedure by the echo cart 22 may be scanned or imported into the physician's work area. As previously indicated, the scanning tool 54 may be used to scan the images or a report page generated by the echo cart 22 and obtain measurements and calculations generated by the echo cart 22. Measurements and calculations obtained by the scanning tool 54 may be rendered on the displayed echo image. The obtained measurements and calculations may be displayed on the echo image prior to launching the supplemental measurement tool 28. Once the supplemental measurement tool 28 is launched, the measurements and calculations obtained by the scanning tool may be listed in the measurement tree 94 and calculation tree 96 as if they were measurements and calculations generated by the supplemental measurement tool 28. The graphical representations of the measurements created by the echo cart 22 may be displayed in a manner to distinguish them from the graphical representations of the measurements generated by the supplemental measurement tool 28. The measurements created by the echo cart 22 and the supplemental measurement tool 28 may be combined if they represent similar measurements to compute an average or composite measurement, or may be kept separate. The measurements made by the echo cart 22 during the procedure may also be combined with the measurements made using the supplemental measurement tool 28 to compute calculations. The measurements made by the echo cart 22 may also be edited by using the supplemental measurement tool 28 or may be read-only to preserve the work done during the procedure. The measurements generated during by the echo cart 22 may be processed in a similar manner as measurements generated by the supplemental measurement tool 28 to create a final report.

The supplemental measurement tool 28 may also be configured to calculate a variety of values based on the measurements that the physician has gathered. The calculation tree 96 contains a list of possible calculations for the measurements listed in the measurement tree. Each calculation listed may be generated from one or more measurement types listed in the measurement tree 94. The measurement types required to compute a calculation may be listed below each calculation listed in the calculation tree 96. The measurement types required for a calculation may be hidden, and to see which measurements types are needed to complete a particular calculation the physician may click on an expand icon or similar mechanism. Clicking, double clicking, or right clicking on measurement types listed beneath a calculation in the calculation tree 96 works in exactly the same manner as clicking, double clicking, or right clicking on measurements types listed in the measurement tree 94.

Right clicking on a calculation listed in the calculation tree 96 brings up a calculation pop-up menu 102 as illustrated in FIG. 8. From this menu the physician can choose to hide or show the calculation. Hiding a calculation may cause it not to be displayed on a completed procedure report generated from the measurements and calculations generated by the supplemental measurement tool 28. Hiding a calculation may also cause it not to be displayed in the calculation tree 96. Conversely, showing a calculation may cause it to be displayed on a generated procedure report. By default, if a calculation has a value it may be shown on a report, otherwise it may be hidden.

In some embodiments, when a measurement value is obtained that is used in a calculation listed in the calculation tree 96, that calculation is automatically calculated or updated as needed. All calculations based on any measurement type that has a value added, edited, or deleted may be automatically updated. Alternatively, the physician may request the update of calculations manually be clicking a refresh or recalculate icon, button, or menu option (not shown).

When the physician has recorded all the measurements he or she desires and is ready to create a procedure report, the physician may click the complete button 104 as illustrated in FIG. 5. Pressing the complete button 104 may cause the supplemental measurement tool 28 to exit or close. A close button 105 may also close or exit the supplemental measurement tool 28. All measurements and corresponding graphical representations, however, may be automatically saved to the work area where they were created when the work area or supplemental measurement tool 28 is closed. The next time the work area is selected previously generated measurements, calculations, and graphical measurement representations may be reloaded and displayed.

In some embodiments, upon pressing the complete button 104, measurements and calculations in the physician's work area are gathered together and output to the storage device 30 where the report generator 32 can access the measurements and/or calculations and create a new procedure report. Echo images may also be saved in the storage device 30 and incorporated into the procedure report. The echo images may be automatically saved and incorporated, may be automatically saved but only incorporated if they contain measurements, may only be saved and/or incorporated if selected by the physician, or any combination thereof. For example, the physician may select an image to save by right clicking on the image and selecting “Save” from a pop-up menu.

The graphical representations generated for the measurements recorded in the physician's work area may also be saved to the storage device 30 or separate storage device. Saving the graphical representations allows the generated measurements to be rerendered on an echo image 80 displayed by the image display application 26. Each graphical representation may include information fields such as a name of the physician who created the measurement, a label that links the graphical representation to an instance of a measurement type, or a report ID that links the graphical representation to a generated procedure report if one exists. The report ID field may be used to save a status of the graphical representation such as whether or not it is associated with a measurement that was included in a completed work area. When the supplemental measurement tool 28 is launched and the corresponding work areas are generated for the displayed echo image 80, if the report ID field of a graphical measurement representation has a value, the supplemental measurement tool 28 may be able to identify that the graphical representation is part of a completed work area. If a displayed echo image 80 has graphical measurement representations associated with it where some graphical representations have report IDs and some do not, separate work areas may be created. For example, if ten graphical measurement representations were found for a particular study, or echo image, where five graphical representations had information fields of Physician name=“bob”, Filter ID=“ ” and five graphical representations had information fields of Physician name=“bob”, Filter ID=“1234” then two work areas are created, one for completed work area 1234 and one for physician “bob.” Each created work area contains five graphical measurement representations. In this way, the supplemental measurement tool 28 is able to tell which graphical measurement representations and corresponding measurements should be used to create a special read-only work area for the study.

When the physician clicks the complete button and after the report has been regenerated, all of the graphical measurement representations in the physician's work area may be saved, and a report identifier of the generated procedure report may also be saved within each of the saved graphical measurement representations. The next time the echo image 80 is displayed by the image display application 26 that is associated with the completed work area, the supplemental measurement tool 28 can display the completed work area with the completed measurements and calculations and corresponding graphical measurement representations. Also, when a physician launches the supplemental measurement tool 28, if a completed work area exists the tool 28 may be configured to make the completed work area the selected work area by default.

In one embodiment, physicians are not allowed to create a second completed work area for an echo image 80. Instead, the embodiment is configured so that the only way a physician can modify a completed work area is to create an amended work area, and then save a completed amended work area containing a new set of measurements, calculations, and corresponding graphical measurement representations. When viewing a completed work area the complete button 104 may no longer be enabled and may be replaced with an amendment button (not shown). The physician may use the amendment button to make a change to the completed work area. Pressing the amendment button may create a copy of the graphical measurement representations and corresponding measurements from the completed work area and create a new work area. This area may be temporary, and may be discarded if the physician exits or closes the supplemental measurement tool 28 without completing the amendment. Should the physician press the close button 105 the physician may be warned that all work done to the amendment may be lost unless the physician completes the amendment. Once the amended work area is created, the physician may record additional measurements and may modify previously recorded measurements.

When generating an amendment, the physician may use the show-completed button 108 on the tool dialog 85 to highlight all the measurements that were included in the original completed work area. The physician may use the show-completed button to keep track of new measurements and previously generated measurements. When creating an amendment the supplemental measurement tool 28 may also be configured to enforce restrictions regarding the previously completed measurement values including not allowing completed measurement values to be deleted or edited. Using the show-completed button 108 may be used to indicate which measurement values can be modified or deleted.

Completing an amendment may create a new completed work area containing the previously completed measurements, or a modified subset thereof if measurements were deleted or edited, and any additional measurements and corresponding graphical representations recorded during the amendment. A new report may be generated for the new amended work area and may be marked as amended for auditing purposes. The graphical measurement representations of the new amended work area may also be saved as previously described with the report ID field of each graphical measurement representation set to reflect the new report generated for the new amended work area. Graphical measurement representations included in the original completed work area may be updated to contain the report ID of the newly generated report. If the previously saved graphical measurement representations are updated to reflect the new report ID, only the most current completed work area with the most recent amendment may be accessed and amended by the supplemental measurement tool 28. The generated procedure reports, however, for each completed work area may be saved and used to review original completed work areas.

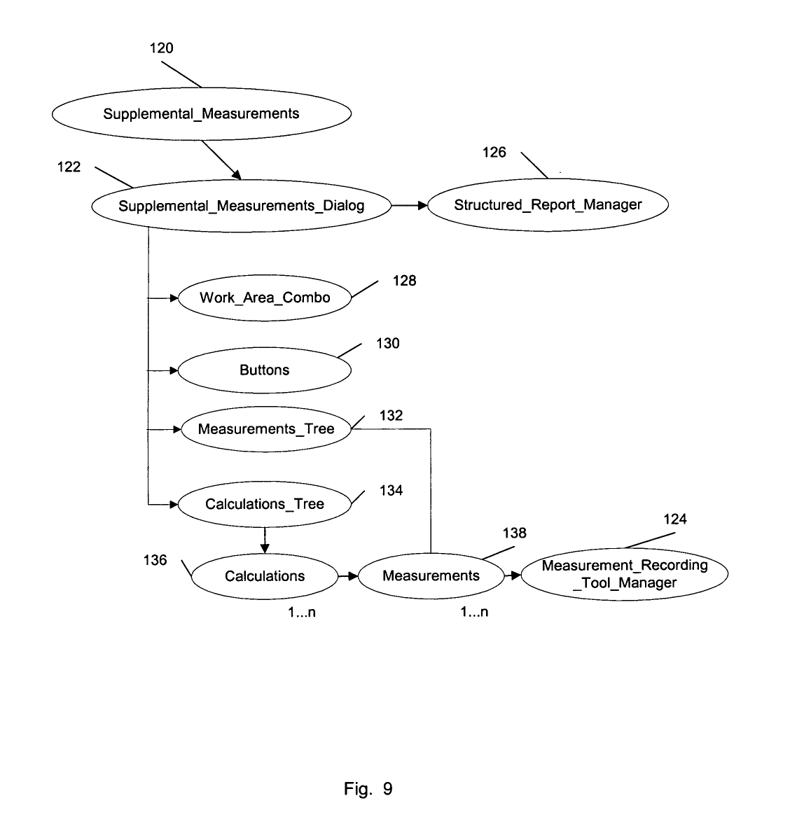

FIG. 9 illustrates an exemplary class structure for the supplemental measurement tool 28 including the tool dialog 85. The classes illustrated in FIG. 9 are top-level classes that may define the internal structure of the supplemental measurement tool 28 component included in the image display application 26. The top class node represents the Supplemental_Measurements class 120 and is used as a parent class to manage and co-ordinate the Supplemental_Measurements_Dialog 122 and Measurement_Recording_Tool_Manager 124 classes. A majority of the classes illustrated in FIG. 9 may be configured as singleton classes where only a single instance of the class is active during the execution of the supplemental measurement tool 28. The Measurements class 138 and Calculations class 136 may be configured where an instance of each class is created for each measurement type and calculation type respectively. The multiple instances of the Measurements class 138 and Calculations class 136 is indicated on FIG. 9 by the 1 . . . n label.

The Supplemental_Measurements_Dialog class 122 is the top level GUI class. It handles the layout of the components of the tool dialog 85, and the interaction between the physician and the components such as identifying mouse clicks and refreshing the tool dialog 85. The tool dialog 85 also acts as a data model that may provide a list of calculations or measurements to a Structured_Report_Manager class 126 or the Measurement_Recording_Tool_Manager class 124. The Supplemental_Measurements_Dialog class 122 also provides the functionality for a Work_Area_Combo class 128, a Buttons class 130, a Measurements_Tree class 132, and a Calculations_Tree class 134. When the physician changes the currently selected work area with the Work_Area_Combo class 128, the Supplemental_Measurements_Dialog class 122 modifies the graphical measurement representations displayed on the echo image 80. Only the graphical measurement representations associated with the currently selected work area are visible on the echo image 80. Also, when the physician clicks the complete button 104 the Supplemental_Measurements_Dialog class 122 handles the creation of a new procedure report and saves, or updates previously saved, the measurements and corresponding graphical representations associated with the report. If a completed report has already been created, the Supplemental_Measurements_Dialog class 122 may change the complete button 104 to an amendment button and display the saved graphical measurement representations for the procedure study. The Supplemental_Measurements_Dialog class 122 may also be responsible for visibly warning a physician that uncompleted amended work areas must be completed before exiting or else they may be lost. In general, the Supplemental_Measurements_Dialog class 122 handles the functionality of buttons and pop-up menus displayed on the tool dialog 85 including the copy-all button 99, delete-all button 100, measurement pop-up menu 98, calculation pop-up menu 102, show-completed button 108, show-all-types button 103, complete button 104, and close button 105.

The Work_Area_Combo class 128, Buttons class 130, Measurements_Tree class 132, and Calculations_Tree class 134 may be created using standard combo box classes, button classes, and tree classes that are all commonly used and well-known in the art.

The Structured_Report_Manager class 126 may retrieve a list of measurement types and the list of calculations from the Supplemental_Measurements_Dialog class 122. The Structured_Report_Manager class 126 may compile the list into a structured document such as an XML document. The Structured_Report_Manager class 126 may also save the XML document to the storage device 30. The XML document may be in a form that the report generator application 32 can read.

The Calculations class 136 may be configured to have a formula for computing a calculation listed in the calculation tree 96. As previously indicated, each calculation type listed in the calculation tree 96 may be associated with an instance of the Calculations class 136. The Calculations class 136 may be constructed to be easily customized to handle a wide variety of calculations. Each instance of the Calculations class 136 may know what measurement types it needs, and may be able to list these measurement types on demand to simplify the construction of the calculations tree 96. Each instance of the Calculations class 136 also may hold a link to every measurement type it requires to calculate its value. An instance of the Calculation class 136 may register itself to be altered of changes to the measurement types that it holds links to. Instances of the Calculation class 136 may also be capable of displaying a calculation value, type, or name, and a list of required measurement types within the calculation tree 96.

Calculations may be determined by accessing measurement values from objects of the Measurements class 138. Also previously noted, each measurement type listed in the measurement tree 94 may be represented by an instance of the Measurements class 138. Each instance of the Measurements class 138 may know its value, which may be an average or a single value from a list of one or more measurement values. Instances of the Measurements class 138 may hold a list of graphical measurement representations and know how to extract values from each of the graphical representations that it contains. Each instance of the Measurements class 138 may register itself to be alerted of changes to the graphical representations that is contains. An instance of the Measurements class 138 may also be capable of displaying a measurement type or name, a list of measurement values, and a parent measurement value within the measurements Tree 94.

The Measurement_Recording_Tool_Manager class 124 handles all interactions between the supplemental measurement tool 28 and the measurements generated and corresponding graphical representations displayed on the echo image 80. The Measurement_Recording_Tool_Manager class 124 may provide a number of services including reading existing graphical measurement representations for an echo image 80 and populating the measurement tree 94 and calculation tree 96 when the supplemental measurement tool 28 is launched. The Measurement_Recording_Tool_Manager class 124 may also be configured to instruct the image display application 26 to display an echo image 80 associated with a graphical measurement representation. The Measurement_Recording_Tool_Manager class 124 may further be responsible for servicing a request for a new measurement or editing an existing measurement. The Measurement_Recording_Tool_Manager class 124 may activate the appropriate measurement recording tool given the measurement type selection of the physician, acquire the measurement and the corresponding graphical representation generated by the activated measurement recording tool, and deactivate the measurement recording tool. The Measurement_Recording_Tool_Manager class 124 may also be responsible for passing the data obtained by the measurement recording tool to the Measurements class 132.

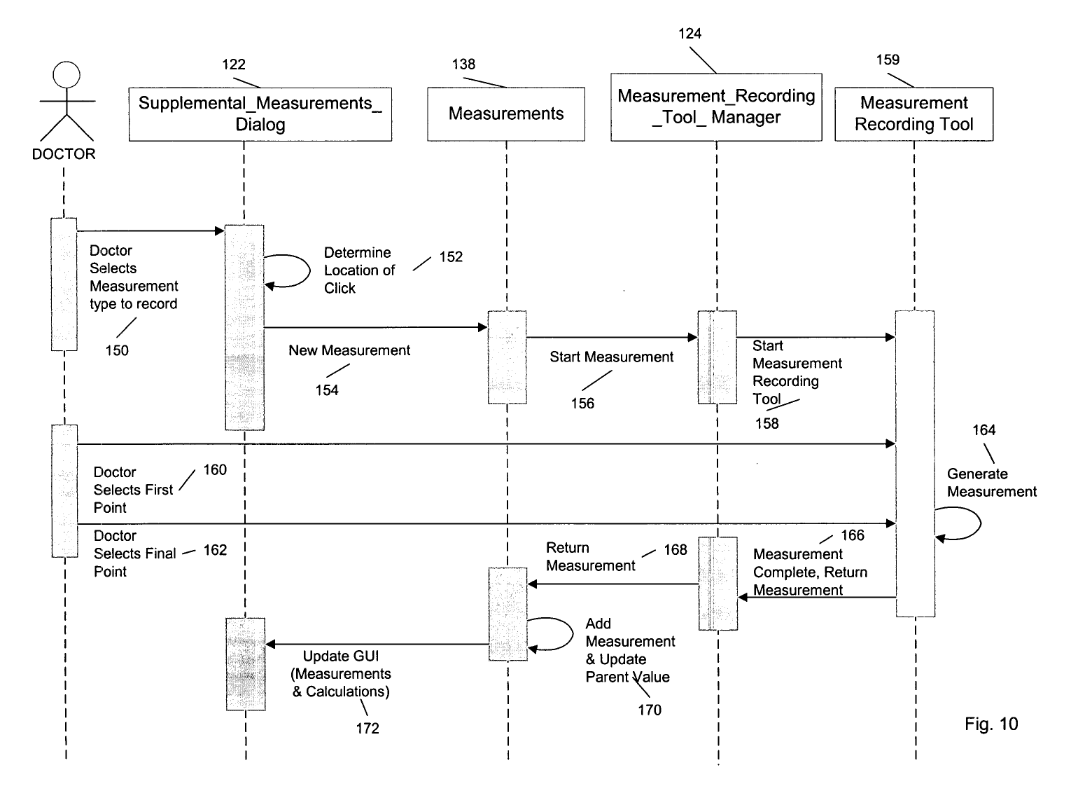

FIG. 10 illustrates exemplary interactions between the classes shown in FIG. 9 when a physician records a measurement. Starting at step 150, a physician selects a measurement type to record using a cursor control device such as a mouse. As previously-described, the physician may select a measurement type to record by double-clicking a measurement type listed in the measurement tree 94 on the tool dialog 85. The physician may also select a measurement type by right-clicking on a measurement type in the measurement tree 94 on the tool dialog 85 and selecting “Add Value” from the measurement pop-up menu 98. Other mechanisms such as buttons or trigger keys may also be used to initiate the process of recording a new measurement.

At step 152 the Supplemental_Measurements_Dialog class 122 determines the location of the click or selection made by the physician on the tool dialog 85. Locating or determining a mouse click location is well known in the art and therefore not described. Depending on the location of the click the Supplemental_Measurements_Dialog class 122 determines what actions need to be taken to service the selection of the physician. For example, if the physician clicks on a button such as the close button 104, the Supplemental_Measurements_Dialog class 122 may interact with an instance of the Buttons class 130 in order to exit the supplemental measurement tool 28. If the physician clicks on a calculation in the calculation tree 96 the Supplemental_Measurements_Dialog class 122 may request data or functionality from the Calculations class 136 in order to highlight measurement types required for the selected calculation.

When the physician clicks on a measurement in the measurement tree 94 of the tool dialog 85, the Supplemental_Measurements_Dialog class 122 may pass control to an instance of the Measurements class 138 corresponding to the selected measurement type so that a new measurement value of the measurement type can be recorded (step 154). Each measurement listed in the measurement tree 94 May have a corresponding instance of the Measurement class 138 configured to request a new measurement value and receive data from the Measurement_Recording_Tool_Manager class 124 obtained by a measurement recording tool.

To start the recording of a new measurement value, the Measurements class 138 passes control to the Measurement_Recording_Tool_Manager class 124. The Measurements class 138 instructs the Measurement_Recording_Tool_Manager class 124 to start a measurement recording for the measurement type selected by the physician (step 156). For example, if the physician selected a “IVSs MM” measurement type by clicking on that measurement type in the measurement tree 94, an instance of the Measurements class 132 controlling “IVSs MM” measurements may inform the Measurement_Recording_Tool_Manager class 124 to start recording a “IVSs MM” measurement.

At step 158, the Measurement_Recording_Tool_Manager class 124 activates a proper measurement recording tool 159 for the measurement type indicated by the Measurements class 138. The measurement recording tool 159 activated by the Measurement_Recording_Tool_Manager class 124 may be a preexisting measurement recording tool 159 available with the image display application 26 or may be a tool written especially for the supplemental measurement tool 28. The measurement recording tool 159 may be used by the supplemental measurement tool 28 to record measurement selections on the displayed echo image 80. For example, if a physician wishes to measure the thickness of a heart wall, he or she may click on each side of the heart wall displayed on the echo image 80. In some embodiments, the measurement recording tool 159 may be configured to determine the locations of the two points or selections, draw a connecting measurement line between the two points, and calculate a distance between the two points. The physician may also click and drag a straight or curved measurement line from one endpoint to another endpoint indicating a measurement line. Other mechanisms for recording physician selections on the displayed echo image 80 are also possible.

After the appropriate measurement recording tool 159 is activated, the measurement recording tool 159 waits for the physician to make his or her measurement points or selections on the displayed echo image 80. At step 160, the physician makes his or her first point selection by clicking on a first point on the displayed echo image 80, and at step 162, the physician makes his or her final point selection by clicking on a second point on the displayed echo image 80. FIG. 10 illustrates the physician making two point selections on the displayed echo image 80, although the physician may make more or less point selections depending on the measurement type. The physician may also indicate his or her point selections by a mechanism other than clicking locations on the displayed echo image 80 with a cursor control device such as a mouse. For example, the physician may use a touch screen or pressure sensitive display screen and stylus to draw on the displayed echo image 80 and indicate the measurement desired. The measurement recording tool 159 may also restrict the physician from selecting points outside a valid ultrasound region of calibration. These calibration regions may be read from the procedure data, if available, or may be manually created by the user using the image display application 26.

After the physician makes the number of point selections required for the selected measurement type the measurement recording tool 159 determines a measurement for the selected points and generates a graphical representation of the measurement (step 164). The measurement may be a distance measurement, a rate of change measurement, a time measurement, etc. The measurement type governs the measurement made on the points selected by the physician. The measurement recording tool 159 evaluates the point selections and determines a measurement for the points selected by the physician. The measurement recording tool 159 may be configured to judge the validity of the point selected. For example, points used in particular measurement types may require certain characteristics or relationships, such as being located on similar structures, forming a continuous line capable of taking a derivative, or the like. The measurement recording tool 159 may also be configured to judge the validity of a resulting measurement value by comparing the value to a range of accepted values. If the calculated measurement does not fall between the valid range of a value, the measurement recording tool 159 may reject the measurement selections and indicate an error or may display the measurement in a predefined color or highlighting or other visible characteristic such that the physician is aware that the measurement is out of range of normal or accepted measurement values. The measurement recording tool 159 generates a graphical representation of the measurement made on the displayed echo image by the physician. The graphical representation of the measurement is displayed on the echo image 80 along with the determined measurement value (i.e., the distance between the two points selected by the physician). The graphical representation may also be saved with the image as a set of points and one or more identifiers, such as a work area identifier or report identifier.

At step 166, the measurement recording tool 159 informs the Measurement_Recording_Tool_Manager class 124 that the measurement is complete and returns data obtained by the measurement recording tool 159 to the Measurement_Recording_Tool_Manager class 124. The Measurement_Recording_Tool_Manager class 124 forwards the data to the Measurements class 138 object that requested the measurement recording (step 168). The instance of the Measurements class 138 receiving the data may add a graphical representation of the measurement to its list of measurements and may obtain the determined measurement value from the graphical representation (step 170). Adding the graphical representation to the Measurements class 138 object's measurement list causes the Measurements class 138 object to watch for changes to the graphical representation that would change the associated measurement value.

Each measurement type may have a single parent value as described above and, if a particular measurement type has more than one measurement value, the parent value for the measurement type may be calculated from the multiple measurement values. The parent value may be the average, the maximum, the minimum, or other mathematical combination of the obtained measurement values. At step 170, the Measurements class 138 object that received the generated graphical representation updates its parent value. Updating the parent value may include setting the parent value to the measurement value of the new graphical representation if the new graphical representation is the first graphical representation for the Measurements class 138 object. The Measurements class 138 object may also obtain the corresponding measurement values of all the graphical representations contained in the object's list of graphical representations in order to calculate a parent value.

After the instance of the Measurements class 138 adds the new graphical representation to its list of graphical representations and updates its parent value, the Measurements class 138 object may instruct the Supplemental_Measurements_Dialog class 122 to refresh and update the tool dialog 85 (step 172). Updating the tool dialog 85 may include instructing each Measurements class 138 object to redisplay each graphical representation contained in its list and its parent value. Updating the tool dialog 85 may also include instructing each Calculations class 136 object to redisplay its value. The values of the calculations may have changed due to changes in the measurement type parent values.

After tool dialog 85 has been updated and refreshed the tool dialog 85 may be ready to record another measurement, edit a measurement, delete a measurement, or the like.

The supplemental measurement tool 28 may also format the recorded measurements, corresponding graphical representations, resulting calculations, and image(s) so that a completed and structured report can be automatically created. A report may be generated from the measurements and calculations in the current physician's work area when they press the complete button 104. The supplemental measurement tool 28 may also associate a physician's name and report UID to every graphical representation generated with the tool 28 so that they can be recreated and marked as part of a completed report.

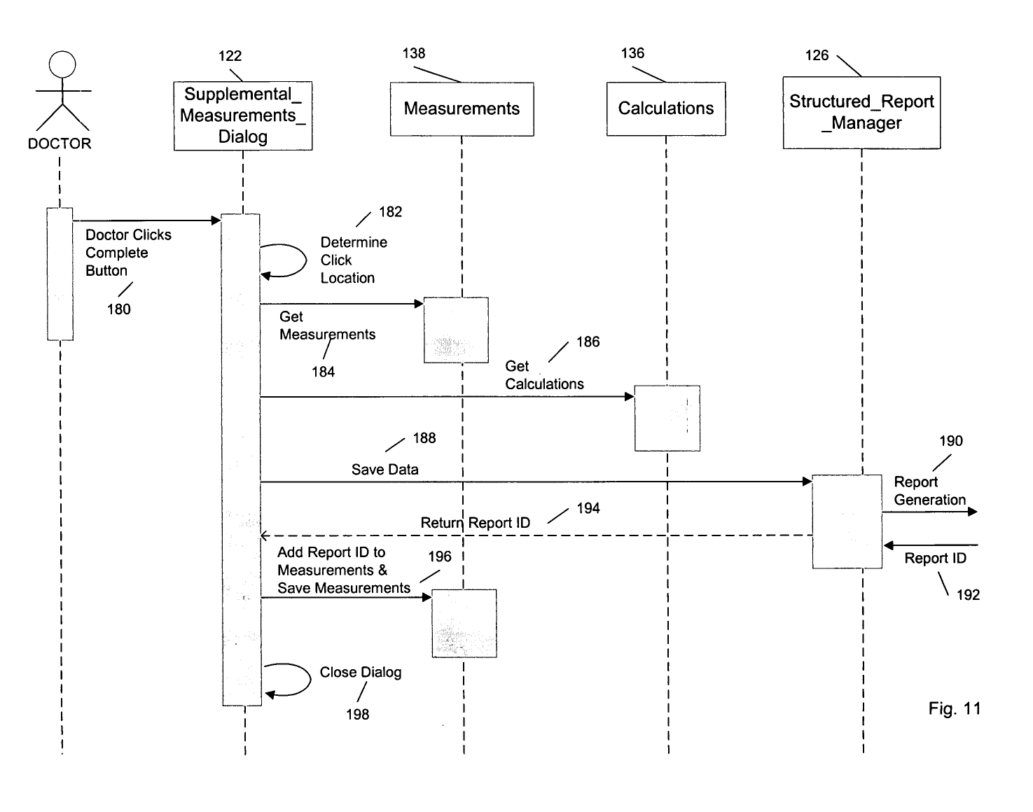

FIG. 11 illustrates exemplary interactions between the classes illustrated in FIG. 9 upon completing a study. Starting at block 180, the physician clicks the complete button 104. At block 182, the Supplemental_Measurements_Dialog class 122 determines the location of the click. Once the Supplemental_Measurements_Dialog class 122 determines the physician has clicked the complete button 104 the Supplemental_Measurements_Dialog class 122 may request the measurement values from each Measurements class 138 object (step 184) corresponding to each measurement type listed in the measurement tree 94. Each Measurements class 138 object may return each graphical representation held in its list or may return the measurement value of each graphical representation to the Supplemental_Measurements_Dialog class 122.

After the Supplemental_Measurements_Dialog class 122 obtains the measurement values, the Supplemental_Measurements_Dialog class 122 requests the calculation values from each Calculations class 136 object (step 186) associated with each calculation listed in the calculation tree 96. Each Calculations class 136 object may return its value to the Supplemental_Measurements_Dialog class 122. Alternatively, the Supplemental_Measurements_Dialog class 122 may be configured to generate the calculation values from the received measurements.

Upon receiving the measurement values and calculations values, the Supplemental_Measurements_Dialog class 122 passes the obtained data to the Structured_Report_Manager class 126, instructing it to save the data. The Structured_Report_Manager class 126 may take the measurements and calculations received from the Supplemental_Measurements_Dialog class 122 and generate an XML document, or other structured form document that the report generator application 23 understands. The Structured_Report_Manager class 126 saves the generated XML document containing the measurements and calculations sent by the Supplemental_Measurements_Dialog class 122 to the storage device 30 (step 188). The Structured_Report_Manager class 126 interacts with the report generator application 32, and the report generator application 32 uses the stored XML document to generate a final report for the ultrasonography procedure (step 190). Alternatively, Supplemental_Measurements_Dialog class 122 may also be responsible for interacting with the report generator application 32.

The report generator application 32 may contain a template or form that it fills in or completes using the data contained in the XML document saved by the Structured_Report_Manager class 126. The XML document generated by the Structured_Report_Manager class 126 may also contain generating instructions that the report generator application 32 executes in order to generate a report.

At step 192 after the report generator application 32 has generated the final report, the report generator application 32 may return a report ID to the Structured_Report_Manager class 126. The report ID may be unique for each report that the report generator application 32 generates and may be used to link saved graphical measurement representations to completed reports.

The Structured_Report_Manager class 126 forwards the returned report ID to the Supplemental_Measurements_Dialog class 122 at step 194. The Supplemental_Measurements_Dialog class 122 may use the report ID to instruct each Measurements class 138 object to add the report ID to each graphical measurement representation contained in its list of graphical measurement representations (step 196). Each Measurements class 138 object may also save the graphical measurement representations containing the report ID. Alternatively, the Supplemental_Measurements_Dialog class 122 may be responsible for receiving the graphical measurement representations from each Measurements class 138 object and updating and/or saving the graphical measurement representations. When the physician views the report generated by the report generator application 32, the saved graphical measurement representations may be used to display the measurements made and stated on the report. Also, when a physician launches the supplemental measurement tool 28 and selects a work area, if a work area has graphical measurement representations that contain a report ID, the measurement tool 28 knows that the graphical measurement representations are part of a completed report and the physician may not be able to edit the work area unless he or she creates an amendment.

In some embodiments, a class other than the Structured_Report_Manager class 126 generates the report ID. For example, the instance of the Supplemental_Measurements_Dialog class 122 may generate a report ID and pass the generated report ID to the instance of the Structured_Report_Manager class 126. The instance of the Structured_Report_Manager class 126 may generate a report and assign it the report ID provided by the Supplemental_Measurements_Dialog class 122.

After the graphical measurement representations have been updated with the report ID and saved, the final report may be ready for viewing and the study of the ultrasonography procedure may be complete. At step 198, the Supplemental_Measurements_Dialog class 122 closes the tool dialog 85. The tool dialog 85 may also remain open after the report has been generated.

It should be noted that although an order is implied in the above descriptions and corresponding figures, the steps and interactions carried out to generate additional measurements and calculations, save the generated measurements, and generate a report from the generated measurements may be performed in various orders and combinations. The functionality of the above described classes may also be combined into one class or further divided amongst additional classes.

The supplemental measurement tool 28 may be further configured to provide other functionality. For example, the supplemental measurement tool 28 may also allow the physician to calibrate images. The supplemental measurement tool 28 may provide calibration of the displayed image, to ensure that all measurements are as accurate as possible. The supplemental measurement tool 28 may also be configured to determine if the displayed image has been calibrated. If no calibration has been applied to the currently displayed image the supplemental measurement tool may prohibit the physician from making measurements on the image until the image has been manually calibrated. The supplemental measurement tool 28 may use a preexisting calibration tool provided by the image display application or other application of the system, or may provide its own calibration process.

The supplemental measurement tool 28 may also allow the user to activate other tools provided by the image display application 26 such as window leveling and magnification, without having to de-activate the supplemental measurement tool 28 first. Because the accuracy of measurements relies on the user's ability to identify key points on the ultrasound image, having those image manipulation features available within the supplemental measurement tool 28 is beneficial.

Another tool that may be provided to the supplemental measurement tool 28 by the image display application 26 is a real-time play tool. The real-time play tool may be implemented with special functionality that allows the real-time play tool and supplemental measurement tool 28 to be active simultaneously. Simultaneous use enhances the usability of supplemental measurement tool 28. The real-time play tool may allow the user to quickly navigate through or play, in real-time, the frames of multi-frame ultrasound images. The real-time play tool and supplemental measurement tool 28 may not directly depend on each other, but may coexist and interact to improve the usability of the supplemental measurement tool 28.

The supplemental measurement tool 28 may also provide buttons and/or menu selections that allow the user to re-size the tool dialog 85 or modify the text within the tool dialog 85. A user may also be able to adjust the way or format that the measurements and/or calculations are displayed in the measurement tree 94 and calculation tree 96. A user may want to perform one or a number of these operations to improve their interaction with the supplemental measurement tool 28.

The supplemental measurement tool 28 may also allow the user to create custom measurements. The supplemental measurement tool 28 may be able to generate a measurement recording tool depending on characteristics of the custom measurement. By supplying the type of measurement (i.e., length or area), the number of end points needed to calculate, and units of the measurement, a measurement recording tool can be constructed and used to record custom measurements.

As should be apparent to one of ordinary skill in the art, the systems shown in the figures are models of what actual systems might be like. Many of the components and logical structures described are capable of being implemented in software which may be stored as instructions on a computer readable medium (such as an optical disc, disc drive, RAM, ROM, etc.) and executed by a microprocessor or a similar device. Many of the same components are also capable of being implemented in hardware using a variety of components including, for example, application specific integrated circuits (“ASICs”). In addition, capitalized terms, such as “Supplemental_Measurements_Dialog” are used. Use of such terms is made to be consistent with common industry and programming practices or to make reference to diagrams easier for the reader. Nothing, however, should be construed as limiting the breadth of such terms merely because they have been capitalized.

It should also be apparent that embodiments of the invention are not limited to echo images. For example, the above system may be utilized to analyze images such as x-rays, images generated during an magnetic resonance imaging (“MRI”) procedure, computed axial tomography (“CAT”) scans, and the like.

Various features and advantages of the invention are set forth in the following claims.

1. A system for generating measurements and calculations on an image previously generated during a procedure, the system comprising:
an image display application configured to display the image previously generated during the procedure; and
a supplemental measurement tool configured to display one or more measurement types to a user, allow the user to select a measurement type, record a measurement made by the user of the selected measurement type on the displayed image, and automatically generate one or more calculations based on the recorded measurements.

2. The system as claimed in claim 1, wherein the supplemental measurement tool is further configured to save the recorded measurement, the one or more generated calculations, and the image.

3. The system as claimed in claim 2, the system further comprising:
a storage device configured to store the image, recorded measurement, and one or more generated calculations saved by the supplemental measurement tool; and
a report generator configured to access the image, recorded measurement, and one or more generated calculations stored in the storage device and generate a procedure report.

4. The system as claimed in claim 3, wherein the supplemental measurement tool is further configured to allow the user to specify whether the image, recorded measurement, or one or more generated calculations should be included in the procedure report generated by the report generator.

5. The system as claimed in claim 1, wherein the image display application is further configured to calibrate the image.

6. The system as claimed in claim 1, wherein the supplemental measurement tool is further configured to display the recorded measurement and generated calculations.

7. The system as claimed in claim 1, wherein the supplemental measurement tool is further configured to record a plurality of measurements for each of the one or more displayed measurements types.

8. The system as claimed in claim 7, wherein the supplemental measurement tool is further configured to calculate a mean measurement for the one or more displayed measurement types when a plurality of measurements is recorded for the one or more displayed measurement types.

9. The system as claimed in claim 1, wherein the supplemental measurement tool is further configured to edit a recorded measurement made by the user.

10. The system as claimed in claim 1, wherein the supplemental measurement tool is further configured to delete a recorded measurement made by the user.

11. The system as claimed in claim 1, wherein the supplemental measurement tool is further configured to obtain procedure data from the displayed image.

12. The system as claimed in claim 11, wherein the supplemental measurement tool is further configured to save the obtained procedure data.

13. A method of generating measurements on an echo image previously generated during a procedure, the method comprising:
displaying the echo image previously generated during the procedure;
displaying measurement types to a user;
allowing the user to select a first measurement type;
determining the first measurement type selected by the user;
recording a first measurement of the first selected measurement type made by the user; and
displaying the first measurement of the first selected measurement type made by the user.

14. The method as claimed in claim 13, further comprising automatically generating one or more calculations based on the first recorded measurement.

15. The method as claimed in claim 13, further comprising:
allowing the user to select a second measurement type;
determining the second measurement type selected by the user;
recording a first measurement of the second selected measurement type made by the user; and
displaying the first measurement of the second selected measurement type made by the user.

16. The method as claimed in claim 15, further comprising generating one or more calculations based on the first measurement of the first selected measurement type and the first measurement of the second selected measurement type.

17. The method as claimed in claim 15, wherein the first and second measurement types are the same measurement type.

18. The method as claimed in claim 17, further comprising calculating a mean measurement based on the first measurement of the first selected measurement type and the first measurement of the second selected measurement type.

19. The method as claimed in claim 13, further comprising editing the first recorded measurement of the first selected measurement type made by the user.

20. The method as claimed in claim 13, further comprising deleting the first recorded measurement of the first selected measurement type made by the user.

21. A computer-readable medium comprising instructions for:
obtaining procedure data from a displayed image;
displaying one or more measurement types;
selecting one of the one or more measurement types;
determining a measurement type selected;
recording a measurement of the selected measurement type made by the user;
displaying the measurement of the selected measurement type made by the user; and
generating one or more calculations based on the recorded measurement.

22. The computer-readable medium as claimed in claim 21, further comprising instructions for saving the recorded measurement.

23. The computer-readable medium as claimed in claim 21, further comprising instructions for saving the generated calculations.

24. The computer-readable medium as claimed in claim 21, further comprising instructions for saving the displayed image.

25. The computer-readable medium as claimed in claim 21, further comprising instructions for editing a recorded measurement made by the user.

26. The computer-readable medium as claimed in claim 21, further comprising instructions for deleting a recorded measurement made by the user.

27. The computer-readable medium as claimed in claim 21, further comprising instructions for defining one or more work areas based on the obtained data.

28. The computer-readable medium as claimed in claim 27, further comprising instructions for associating the recorded measurement with one of the one or more work areas.

29. The computer-readable medium as claimed in claim 28, further comprising instructions for copying the recorded measurement to one of the one or more work areas that is different from the work area associated with the recorded measurement.
